(19) United States
(12) Patent Application Publication
(10) Pub. No.: US 2013/0324493 A1
(43) Pub. Date: Dec. 5, 2013

(54) COMPOSITIONS COMPRISING NINGNANMYCIN AND USES THEREFOR

(71) Applicant: North Carolina State University, Raleigh, NC (US)

(72) Inventors: Bangya Ma, Cary, NC (US); Lane P. Tredway, Knightdale, NC (US)

(73) Assignee: North Carolina State University, Raleigh, NC (US)

(21) Appl. No.: 13/906,498

(22) Filed: May 31, 2013

Related U.S. Application Data
(60) Provisional application No. 61/705,801, filed on Sep. 26, 2012.
(60) Provisional application No. 61/654,357, filed on Jun. 1, 2012.

(51) Int. Cl. A01N 43/54

(52) U.S. Cl. CPC A01N 43/54
USPC 514/49

(57) ABSTRACT

Provided herein are compositions comprising ningnanmycin or a derivative thereof, as well as their use for controlling or combating a fungal infection in a plant or plant part (e.g., a turfgrass).

### RELATED APPLICATIONS

This application claims the benefit of U.S. Provisional Patent Application Ser. No. 61/654,357, filed Jun. 1, 2012, and U.S. Provisional Patent Application Ser. No. 61/705,801, filed Sep. 26, 2012, the disclosure of each of which is incorporated by reference herein in its entirety.

### FIELD OF THE INVENTION

The present disclosure relates to compositions comprising ningnanmycin and its use for controlling or combating a fungal infection in a plant or plant part.

### BACKGROUND

Management of fungal diseases such as dollar spot, caused by the fungal pathogen Sclerotinia homoeocaipa, is a top priority in pest management on golf course turfgrasses, and chemical fungicides are applied on a regular basis in order to maintain an appealing and disease-free turf. However, overreliance on chemical control strategies is not sustainable for economic, environmental, and biological reasons. For example, populations of the dollar spot pathogen have developed resistance to several classes of fungicides, including the benzimidazole, dicarboximide, and DMI fungicides. See Bishop et al., 2008. Resistance of Sclerotinia homoeocarpa to iprodione, propiconazole, and thiophanate-methyl in Tennessee and northern Mississippi. Crop Sci. 48:1615-1620; Detweiler et al., 1983. Resistance of Sclerotinia homoeocaipa to iprodione and benomyl. Plant Dis. 67:627-630; Golembiewski et al., 1995. Detection of Demethylation Inhibitor (DMI) resistance in Sclerotinia homoeocarpa populations. Plant Dis 79:491-493; Hsiang et al., 2007. Sensitivity of Sclerotinia homoeocarpa to demethylation-inhibiting fungicides in Ontario, Canada, after a decade of use. Plant Pathol. 56:500-507; Jo et al., 2006. Fungicide sensitivity of Sclerotinia homoeocarpa from golf courses in Ohio. Plant Dis. 90:807-813; Koch et al., 2009. Thiophanate-methyl and propiconazole sensitivity in Sclerotinia homoeocarpa populations from golf courses in Wisconsin and Massachusetts. Plant Dis. 93:100-105; Putman et al., 2010. Geographic distribution of fungicide-insensitive Sclerotinia homoeocarpa isolates from golf courses in the northeastern United States. Plant Dis. 94:186-195; Vargas, J. M. 2005. MANAGEMENT OF TURFGRASS DISEASES, John Wiley & Sons. Inc., Hoboken, N.J.

As opposed to a crop, which is planted and cultured to produce a marketable yield, golf course grasses are cultured and maintained to produce a playing surface, often within specific guidelines related to firmness, smoothness and uniformity. Due to these differences, different pathogens tend to infect turfgrasses, and different agents and management systems are needed. Furthermore, different levels of control are often required for turfgrasses as compared to crops.

An overreliance on fungicides for the control of anthracnose has also led to the development of resistance, further limiting the strategies available for fungal control. See Wong et al., 2008. Detection and characterization of benzimidazole resistance in California populations of Colletotrichum cereale. Plant Dis. 92:239-246; Wong et al., 2007. Occurrence and distribution of QoI-resistant isolates of Colletotrichum cereale from annual bluegrass in California. Plant Dis. 91:1536-1546; Young et al., 2010. Two Mutations in beta-Tubulin 2 Gene Associated with Thiophanate-Methyl Resistance in Colletotrichum cereale Isolates from Creeping Bentgrass in Mississippi and Alabama. Plant Dis. 94:207-212; Young et al., 2010. Occurrence and Molecular Identification of Azoxystrobin-Resistant Colletotrichum cereale Isolates from Golf Course Putting Greens in the Southern United States. Plant Dis. 94:751-757.

Currently available biocides based on biocontrol agents such as Trichoderma spp. and Bacillus spp. have shown some promise in turfgrasses; however, the level of control these agents provide is generally lower than that desired by the golf industry. See Vincelli, P. 2012. Chemical control of turfgrass diseases 2012. University of Kentucky, Lexington, Ky. Polyoxins, a group of biochemical fungicides produced through fermentation of soil actinomycetes, Streptomyces cacoi var. asoensis, have proven mainly effective for diseases caused by Rhizoctonia species. See Isono et al., 1965. Studies on polyoxins, antifungal antibiotics Part I. Isolation and characterization of polyoxins A and B. Agric. Biol. Chem. 29:848-854.

Therefore, additional strategies for fungal control are needed for cultivated plants, particularly turfgrasses.

### SUMMARY

Provided herein are compositions comprising ningnanmycin or a derivative thereof, as well as their use for controlling or combating a fungal infection in a plant or plant part (e.g., methods for controlling a fungal infection).

In some embodiments, the compound is applied to the plant in an amount effective to treat or control a fungal disease selected from the group consisting of rots, leaf molds, blights, wilts, damping-off, spot, root rot, stem rot, mildew, brown spot, gummosis, melanose, post-bloom fruit drop, scab, alternaria, canker, flyspeck, fruit blotch, dieback, downy mildews, ear rots, anthracnose bunts, smut, rust, eyespot and pecky rice.

In some embodiments, the plant is a turfgrass (e.g., bahiagrass, bentgrass such as creeping bentgrass and colonial bentgrass, bermudagrass, hybrid bermudagrass, bluegrass such as annual bluegrass, Kentucky bluegrass or rough bluegrass, buffalograss, carpetgrass, centipedegrass, fescue such as fine fescue or tall fescue, ryegrass such as annual ryegrass or perennial ryegrass, kikuyugrass, orchardgrass, quackgrass, seashore paspalum, St. Augustinegrass, zoysiagrass, etc.).

In some embodiments, the plant is a turfgrass, and the compound is applied in an amount effective to treat or control one or more fungal diseases selected from the group consisting of: Ascochyta Leaf Blight, Brown Stripe, Cephalosporium Stripe, Cercospora Leaf Spot, Cladosporium Eyespot, Copper Spot (Zonate Leaf Spot), Dollar Spot, Gray Leaf Spot, Leaf Blotch (Scald), Leaf Smut, Leptoshaerulina Leaf Blight, Mastigosporium Leaf Spot, Phyllosticta Leaf Blight, Physoderma Leaf Spot, Physoderma Leaf Streak, Pink Patch Leaf Bight, Cream Leaf Bight, Powdery Mildew, Pseudoseptoria Leaf Spot, Red Thread, Rust, Septoria Leaf Spot, Stagnospora Leaf Spot, Snow Mold, Coprinus Snow Mold, Microdochium Patch, Snow Scald, Typhula Blight, Spermospora Leaf Spot, Tar Sport, Yellow Tuft (Downy Mildew), Anthracnose, Bipolaris Disease (Melting Out), Exseohilum Disease, Curvularia Disease, Drechslera Disease, Marielliottia Disease, Fusarium Disease, Nigrospora Blight, Pythium Disease, Rhizoctonia Disease, Seedling Disease, Southern Blight, Dead Spot, Necrotic Ring Spot, Root Decline of Warm-Season Turfgrasses, Spring Dead Spot, Summer Patch, Red Leaf Spot, Fairy Rings, Algae, Large patch, Net Blotch, Slime Mold, White Patch, Yellow Patch, and Take-all Patch.

In some embodiments, the plant is turfgrass, and the compound is applied in an amount effective to treat or control Dollar spot, such as that caused by Sclerotinia homoeocarpa.

In some embodiments, the plant is turfgrass, and the compound is applied in an amount effective to treat or control anthracnose, such as that caused by Colletotrichum cereale.

In some embodiments, the methods include applying a composition comprising ningnanmycin; and applying a composition comprising another fungicide to said plant or plant part thereof in an amount effective to control said fungal disease. In some embodiments, the compositions are applied concurrently (e.g., sequentially or simultaneously).

A further aspect of the present disclosure is an agricultural composition comprising: (a) an agriculturally acceptable carrier (e.g., an aqueous carrier or a solid particulate carrier); and (b) a composition comprising ningnanmycin, or an agriculturally acceptable salt thereof. In some embodiments, the composition further comprises another fungicide.

### DETAILED DESCRIPTION OF PREFERRED EMBODIMENTS

The present invention is further described below. All patent references referred to in this patent application are hereby incorporated by reference in their entirety as if set forth fully herein.

“Ningnanmycin” is a compound produced upon fermentation of the soil actinomycete bacteria Streptomyces noursei, var. Xichangensis (also known as the Knowles Streptomyces Xichang variant), and is commercially available (e.g., Deqiang Biological Co., LTD (formerly Qianer), Harbin, Helongjiang, China; Greeno Chemical Co., Ltd., Shanghai, China). Its chemical structure is presented in Scheme 1 below.

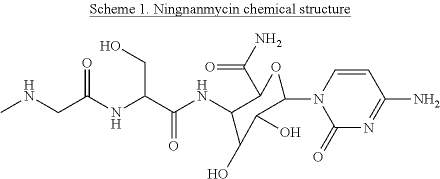 [SMILES: CNCC(=O)NC(CO)C(=O)NC1C(C(N)=O)OC(n2ccc(N)nc2=O)C(O)C1O]

It should be understood that a composition comprising ningnanmycin includes that of the compound, itself, whether produced by fermentation, or synthetically, or otherwise produced in vitro (e.g., enzymatically), whether the compound is isolated or purified (e.g., comprising at least 5%, 10%, 15%, 20%, 30%, 50%, 70%, 80%, or 90% by weight of the composition), provided as a crude fermentation product sample, a condensed/formulated fermentation product, with the bacteria, etc. As will be understood, one or more other fermentation products may be included in the composition, if desired, such as:

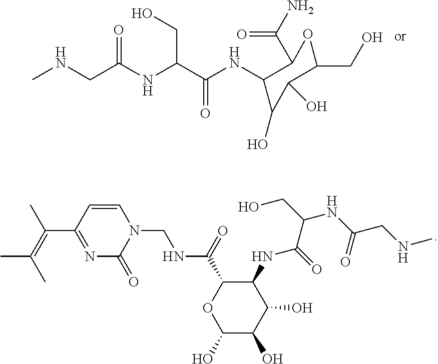 [SMILES: CNCC(=O)NC(CO)C(=O)NC1C(C(N)=O)OC(CO)C(O)C1O ; "or" ; CNCC(=O)NC(CO)C(=O)N[C@H]1[C@H](O)[C@@H](O)[C@H](O)O[C@@H]1C(=O)NCn1ccc(C(C)=C(C)C)nc1=O]

See CN101978827 (Chinese patent application: Ningnanmycin composition and preparation method thereof).

Ningnanmycin has been used as a bio-pesticide as well as an anti-viral in crop plants. Activity against certain fungi in certain crop plants has also been reported, though this effect or mode of action of the compound is not understood.

“Plant” as used herein includes all members of the plant kingdom, including higher (or “vascular”) plants and lower (“non-vascular”) plants, including all plants in the divisions Filicinae, Gymnospermae (or “gymnosperm”), and Angiospermae (or “Angiosperm”). Nonvascular plants of the present disclosure include, but are not limited to, bryophytes.

For example, a plant of the present disclosure includes, but is not limited to, a crop plant, a turfgrass, an ornamental species, a species grown for timber or pulp, a species grown for biofuels or a species grown for pharmaceuticals. Additionally, plants of the present disclosure include, but are not limited to, tobacco, tomato, potato, sugar beet, pea, carrot, cauliflower, broccoli, soybean, canola, sunflower, alfalfa, cotton, rapeseed, Arabidopsis, peach, pepper, apple, chili, peanut, orange, grape, coffee, cassaya, spinach, lettuce, cucumber, wheat, maize, rye, rice, grass (e.g., turfgrass, leaf and stem crops (e.g., bamboo, marram grass, meadowgrass, reeds, sugarcane, etc.), ornamental grasses, etc.), oat, barley, sorghum, millet, sugarcane, or banana.

“Plant part” as used herein refers to seeds, roots, leaves, shoots, fruits (e.g., apples, pineapples, citrus fruit, etc.), vegetables, tubers, flowers (e.g., cut flowers such as roses, as well as the reproductive parts of plants), petals, stem, trunk, etc., harvested or collected from a plant as described herein. The plant part of a vascular plant may be a non-vascular part, such as a seed or meristem (growing tip of a shoot).

“Turfgrass” is known as grass useful for covering a surface area of ground, typically subject to regular maintenance, such as golf courses and other commercial or residential turf areas such as athletic fields, lawns, municipal areas and cemeteries, or other ornamental turf areas, and is typically an annual or perennial of the monocot family Gramineae or Poaceae (e.g., genera Agropyron, Agrostis, Axonopus, Bromus, Buchloe, Cynodon, Eremochloa, Festuca, Lolium, Paspulum, Pennisetum, Phleum, Poa, Stenotaphrum or Zoysia). Turfgrass includes cool season turfgrass and warm season turfgrass. See also U.S. Patent Application Publication No. 2009/0306166 to Herman et al., which is incorporated by reference herein.

Examples of cool season turfgrasses include, but are not limited to, Bluegrasses (Poa L.), such as Kentucky Bluegrass (Poa pratensis L.), Rough Bluegrass (Poa trivialis L.), Canada Bluegrass (Poa compressa L.) and Annual Bluegrass (Poa annua L.); Bentgrasses (Agrostis L.), such as Creeping Bentgrass (Agrostis palustris Huds.), Colonial Bentgrass (Agrostis tenius Sibth.), Velvet Bentgrass (Agrostis canina L.) and Redtop (Agrostis alba L.); Fescues (Festuca L.), such as Creeping Red Fescue (Festuca rubra L.), Chewings Fescue (Festuca rubra var. commutata Gaud.), Sheep Fescue (Festuca ovina L.), Hard Fescue (Festuca longifolia), Tall Fescue (Festuca arundinacea Schreb.), Meadow Fescue (Festuca elation L.); Ryegrasses (Lolium L.), such as Perennial Ryegrass (Lolium perenne L.), Annual (Italian) Ryegrass (Lolium multiflorum Lam.); Wheatgrasses (Agropyron Gaerin.), such as Fairway Wheatgrass (Agropyron cristatum (L.) Gaertn,), Western Wheatgrass (Agropyron smithii Rydb.). Other cool season turfgrasses include Smooth Brome (Bromus inermis Leyss.) and Timothy (Phleum L.).

Examples of warm season turfgrasses include, but are not limited to, Bermudagrasses (Cynodon L. C. Rich), Zoysiagrasses (Zoysia Willd.), St. Augustinegrass (Stenotaphrum secundatum (Walt.) Kuntze), Centipedegrass (Eremochloa ophiuroides (Munro.) Hack.), Carpetgrass (Axonopus Beauv.), Bahiagrass (Paspalum notatum Flugge.), Kikuyugrass (Pennisetum clandestinum Hochst. ex Chiov.), Buffalograss (Buchloe dactyloides (Nutt.) Engelm.) and Seashore paspalum (Paspalum vaginatum swartz).

Phytopathogenic fungi that may affect turfgrass, in particular, include Ascochyta Leaf Blight, Brown Stripe, Cephalosporium Stripe, Cercospora Leaf Spot, Cladosporium Eyespot, Copper Spot (Zonate Leaf Spot), Dollar Spot, Gray Leaf Spot, Leaf Blotch (Scald), Leaf Smut, Leptoshaerulina Leaf Blight, Mastigosporium Leaf Spot, Phyllosticta Leaf Blight, Physoderma Leaf Spot, Physoderma Leaf Streak, Pink Patch Leaf Bight, Cream Leaf Bight, Powdery Mildew, Pseudoseptoria Leaf Spot, Red Thread, Rust, Septoria Leaf Spot, Stagnospora Leaf Spot, Snow Mold, Coprinus Snow Mold, Microdochium Patch, Snow Scald, Typhula Blight, Spermospora Leaf Spot, Tar Sport, Yellow Tuft (Downy Mildew), Anthracnose, Bipolaris Disease (Melting Out), Exseohilum Disease, Curvularia Disease, Drechslera Disease, Marielliottia Disease, Fusarium Disease, Nigrospora Blight, Pythium Disease, Rhizoctonia Disease, Seedling Disease, Southern Blight, Dead Spot, Necrotic Ring Spot, Root Decline of Warm-Season Turfgrasses, Spring Dead Spot, Summer Patch, Red Leaf Spot, Fairy Rings, Algae, Large patch, Net Blotch, Slime Mold, White Patch, Yellow Patch, and Take-all Patch. In some embodiments, the methods taught herein are particularly effective to protect turfgrass against one or more of these fungal pathogens.

In some embodiments, the methods taught herein are particularly effective to protect turfgrass against Scherotinia spp. In some embodiments, the methods taught herein are particularly effective to protect turfgrass against Sclerotinia homoeocarpa.

In some embodiments, the methods taught herein are particularly effective to protect turfgrass against Colletotrichum spp. In some embodiments, the methods taught herein are particularly effective to protect turfgrass against Colletotrichum cereale.

In some embodiments, the methods taught herein are particularly effective to protect turfgrass against Ophiosphaerella spp. In some embodiments, the methods taught herein are particularly effective to protect turfgrass against Ophiosphaerella herpotricha (spring dead spot).

In some embodiments, the methods taught herein are particularly effective to protect turfgrass against Magnaporthe spp. In some embodiments, the methods taught herein are particularly effective to protect turfgrass against Magnaporthe poae (summer patch). In some embodiments, the methods taught herein are particularly effective to protect turfgrass against M. griesea (turf gray leaf spot).

“Protecting” or “controlling” a fungal infection refers to inhibition of the establishment or growth of a fungus on a plant or plant part, and/or a decrease in the amount of organisms (number and/or surface area affected) that attach and/or grow on or in a plant or plant part, etc., typically resulting in decreasing fungal infection symptoms, promoting the overall plant growth, appearance, or other desirable qualities, etc. See also U.S. Patent Application Publication No. 2005/0096229 to Benner et al., which is incorporated by reference herein.

“Applying” as described herein can be carried out directly or indirectly by any suitable technique, including topically or systemically applying to the plant or plant part, applying to the media in which the plant or plant part is grown, stored, displayed or maintained (e.g., adding to water in which the stems of cut flowers are placed), etc. Note that the plant may be grown in any suitable media, including, but not limited to, soil, potting soil, soilless media such as sand, hydroponic media (including solution culture, medium culture, deep water culture, aeroponic culture), etc.

“Agricultural composition” as described herein may be in any suitable form, including, but not limited to: wettable powders, dry flowables, soluble powders, water dispersibles, liquids, dusts, emulsifiable concentrates, flowables, fumigants, water dispersible granules, liquid concentrates, granules, water soluble packages, wettable powders in water soluble films, emulsions, etc.

Active compounds can be applied to plants or plant loci in accordance with known techniques. The compound(s) can be tank mixed with other agricultural, turf, ornamental nursery, forestry and all other plant-labeled compatible fungicides, pesticides, etc. The compound(s) can be applied to seed. The compound(s) can be applied to edible and non-edible crops. The compound(s) can be applied to roots and all other parts of all plants. The compound(s) can be applied in greenhouses. The compound(s) can be applied and used in food-processing facilities. The compound(s) can be applied to plastic food bags and containers. The compound(s) can be applied as a solid, as its free base, or as a salt. The salts can include, but are not limited to, HI, HCl, HBr, H₂SO₄, acetic acid, and trifluoroacetic acid. The compound(s) can be applied as a solution from 0.0001% to 99.9%. The compound(s) can be applied as a solid or solution with copper-based cidal compounds. The compound(s) can be applied with specific additional active agents, including but not limited to bactericides, fungicides, pesticides, biological insecticides and microbial insecticides.

Application can be carried out with any suitable equipment or technique, such as: Aerial—Fixed wing and Helicopter; Ground Broadcast Spray—Boom or boomless system, pull-type sprayer, floaters, pick-up sprayers, spray coupes, speed sprayers, and other broadcast equipment, water wagons and water bags; Low pressure boom sprayers, High pressure sprayers; Air blast sprayers; Low volume air sprayers (mist blowers); Ultra-low volume sprayers (ULV); Aerosol Generators (foggers); Dusters; Soil Injector; Hand-Held or High-Volume Spray Equipment—knapsack and backpack sprayers, pump-up pressure sprayers, hand guns, motorized spray equipment; Selective Equipment—Recirculating sprayers, shielded and hooded sprayers; Controlled droplet applicator (CDA) hand-held or boom-mounted applicators that produce a spray consisting of a narrow range of droplet size; Any and all greenhouse sprayers; Micro-sprinkler or drip irrigation systems; Chemigation.

One method of applying an active compound, or an agrochemical composition which contains at least one of said compounds, is foliar application. The frequency of application and the rate of application will depend on the risk of infestation by the corresponding pathogen. However, the active compounds can also penetrate the plant through the roots via the soil (systemic action) by drenching the locus of the plant with a liquid formulation, or by applying the compounds in solid form to the soil, e.g. in granular form (soil application). In crops of water such as rice, such granulates can be applied to the flooded rice field. The active compounds may also be applied to seeds (coating) by impregnating the seeds or tubers either with a liquid formulation of the fungicide or coating them with a solid formulation.

The term “locus” as used herein is intended to embrace the fields on which the treated plants are growing, or where the seeds of cultivated plants are sown, or the place where the seed will be placed into the soil. The term seed is intended to embrace plant propagating material such as cuttings, seedlings, seeds, and germinated or soaked seeds.

Advantageous rates of application in some embodiments may be from 5 g to 2, 3, 4, 5, 8 or 10 kg, or 50, 100, 300, or 500 kg, of active ingredient (a.i.) per hectare (ha). In some embodiments, rates of application are from 10 g to 1 kg a.i./ha, or from 20 g to 600 g a.i./ha. When used as a seed drenching agent, convenient dosages are from 10 mg to 1 g of active substance per kg of seeds. In some embodiments, rates of application are from 0.1 kg/ha to 10 kg/ha, or from 0.5 kg/ha to 5 kg/ha, or from 1 kg/ha to 3 kg/ha. Of course, rates of application may be adjusted, as desired, based upon disease pressure.

Applications according to some embodiments may be within a period of time that ranges from minutes (e.g., 1, 5, 10, 30, 60, or 90 minutes or more) to days (e.g., 1, 2, 5, 8 or 10 or more days), as appropriate for efficacious treatment. The active ingredient can be used in 1 week, 10 days, 2 weeks, or 3 weeks intervals depending on the application rate and the level of disease pressure.

In some embodiments, the active ingredient (ningnanmycin) is provided in an aqueous composition useful for foliar application to turfgrasses. For example, in some embodiments the a.i. may be provided at a concentration of from 0.001, 0.05, 0.01, or 0.1 micrograms per milliliter, to 1, 5, 10 or 20 micrograms per milliliter.

In some embodiments, ningnanmycin is applied at a rate of 0.01, 0.05, 0.10, 0.15, 0.20, 0.25, 0.30, 0.35, 0.40, 0.45, 0.50, 0.55, 0.60, 0.65, 0.70, 0.75, 0.80, 0.85, 0.90, 0.95, or 1.0 grams per square meter. In some embodiments, ningnamycin is applied at an interval of every 5, 7, 10, 14, or 21 days.

Ningnanmycin can be used alone, or along with (e.g., sequentially or in rotation with) another antifungal agent. Examples of known antifungal agents useful in fungal control in turfgrasses include, but are not limited to, benzamides (e.g., fluopicolide), benzothiadiazoles (e.g., acibenzolar-5-methyl), biocontrol agents (e.g., Bacillus licheniformis, Bacillus subtilis strain QST 713, Trichoderma Harzianum), carbamates (e.g., propamocarb), carboximides (e.g., boscalid, flutolanil), chloronitriles (e.g., chlorothalonil), cyanoimidaozles (e.g., cyazofamid), dicarboximides (e.g., iprodione, vinclozolin), dithiocarbamates (e.g., thiram), demethylation inhibitors (DMI), ethylene bis-dithiocarbamates (e.g., ancozeb), miscellaneous aromatics (e.g., chloroneb, pentachloronitrobenzene (PCNB) or quintozene), methyl benzimidazole carbamate (e.g., thiophanate-methyl), oxidizing agents (e.g., hydrogen dioxide), phenylamides (e.g., mefenoxam, metalaxyl), phenylpyrrole (e.g., fludioxonil), phosphonates (e.g., fosetyl-A1, phosphite (salts of phosphorous acid)), phthalimides (e.g., captan), polyoxins (e.g., polyoxid D zinc salt), strobilurins (e.g., azoxystrobin, fluoxastrobin, pyraclostrobin, trifloxystrobin), and triadiazoles (e.g., etridiazole).

A “demethylation inhibitor fungicide” or “DMI fungicide” is a fungicide that acts as a demethylation inhibitor to inhibit the growth of many plant pathogenic fungi (see, e.g., Coolbaugh et al. 1982 b). Examples known in the art include, but are not limited to, fenarimol (e.g., Rubigan) flutriafol (e.g., SP2169), metconazole (e.g., Tourney), myclobutanil (e.g., Eagle), propiconazole (e.g., Banner Maxx), tebuconazole (e.g., Torque), triadimefon (e.g., Bayleton Flo), and triticonazole (e.g., Trinity, Triton Flo).

In some embodiments, the fungicide is a contact, translaminar or systemic fungicide. “Contact” fungicides are not taken up into the plant tissue in significant quantities, and thus only protect the plant where the spray is deposited. “Translaminar” fungicides may be taken up by the plant to the extent that it is redistributed from the sprayed leaf surface to the other, unsprayed surface. “Systemic” fungicides are taken up by the plant and through the xylem vessels to the upper parts of the plant, where it may also protect new leaf growth for a short period of time.

As used herein, the application of two or more compounds (inclusive of ningnanmycin and another fungicide) “in combination” means that the two compounds are applied closely enough in time that the application of or presence of one alters the biological effects of the other. The two compounds may be applied simultaneously (concurrently or contemporaneous) or sequentially.

Simultaneous, concurrent or contemporaneous application of the compounds may be carried out by mixing the compounds prior to application, or by applying the compounds at the same point in time but at different sites of the plant or using different types of applications, or applied at times sufficiently close that the results observed are indistinguishable from those achieved when the compounds are applied at the same point in time.

Sequential application of the compounds may be carried out by applying, e.g., an active compound, at some point in time prior to application of a fungicide, such that the prior application of active compound enhances the effects of the fungicide (e.g., percentage of fungus killed and/or slowing the growth of fungus/fungal infection). In some embodiments, an active compound is applied at some point in time prior to the initial application of a fungicide. Alternatively, the fungicide may be applied at some point in time prior to the application of an active compound, and optionally, applied again at some point in time after the application of an active compound.

Some aspects of the present invention are described in more detail in the following non-limiting examples.

### EXAMPLES

Ningnanmycin, a bio-pesticide produced from fermentation byproducts of the soil actinomycete Streptomyces noursei var. xichangensis n. var, was evaluated for its in vitro activity against Sclerotinia homoeocarpa (the causal agent of dollar spot) and Colletotrichum cereale (the causal agent of anthracnose) using a three-fold dilution from 0.81 to 0.01 μg/ml. Three isolates of S. homoeocarpa and two isolates of C. cereale were selected for the assay. Triticonazole was included as a standard for comparison. The mean EC₅₀ values of S. homoeocarpa and C. cereale were 0.01 and 0.30 μg/ml, respectively, for ningnanmycin compared to 0.05 and 0.98 μg/ml for triticonazole. In field efficacy experiments over two growing seasons, ningnanmycin 10% WP at 0.15 g/m² and 0.30 g/m² applied on a 7-day interval consistently provided similar or superior control of anthracnose and dollar spot compared to Trinity 1.69S at 0.32 ml/m² (14-day interval). Higher rates of ningnanmycin provided extended period of disease control. The results of in vitro sensitivity assays and field efficacy experiments demonstrate that ningnanmycin has activities against two major turfgrass pathogens and can provide similar levels of control compared to traditional fungicides.

Similar to polyoxins, ningnanmycin (4-sarcosinamido-L-serinamido-4-deoxy-β-D-pyranoglucuronamido) is also produced as a fermentation product from Streptomyces, but by the species S. noursei var. xichangensis (Chenet al. 1983. Identification of Streptomyces noursei var. xichangesis. Acta Microbiologica Sinica 23 (4):305-308). It was discovered during the 1980s and has been used commercially in China since 1998 on various crops, including cereals, vegetables and tobacco.

One of the unique attributes of ningnanmycin is that it has activity on plant diseases caused by viruses and by fungi. It has been widely used for diseases caused by Tobacco mosaic virus (TMV) and Rice stripe virus. It is also used against powdery mildew in cereal and vegetables, though the mode of action for antifungal activity is currently unknown. There are many different fungi causing powdery mildew on plants, and the fungi are specific to their host and do not survive without a proper host. Furthermore, chemicals used to control powdery mildew are different from these controlling dollar spot and anthracnose. Sulfur, neem oil, triforine, potassium bicarbonate and QoIs are effective materials for powdery mildew, but not effective for dollar spot or anthracnose (see Penn State Extension, College of Agricultural Sciences, Plant Disease Fact Sheets: Powdery Mildew), whereas effective dollar spot and anthracnose fungicide such as iprodione does not have activity on powdery mildew (see Chemical Control of Turfgrass Diseases 2012, University of Kentucky).

In addition, ningnanmycin has very low toxicity to mammals, and no carcinogenicity, reproductive toxicity, or developmental effects have been observed (Hu et al. 1997. A new agricultural antibiotic-ningnanmycin. China Patent: ZL 93104287.9). Due to its nature as a metabolite from a soil microbe, degradation in the environment occurs rapidly with low or no residues detected in treated crops and soil. In addition, no adverse effects were observed in non-target organisms such as earthworms (Table 1).

TABLE 1
Toxicological and ecological data of ningnanmycin in comparison to
triticonazole.

| | | | Ningnanmycin^{z} | Triticonazole^{y} |
|---|---|---|---|---|
| Acute toxicity | Oral | rat | 6,810 mg/kg (male) | >5,000 mg/kg |
| | LD₅₀ | | 12,100 mg/kg (female) | |
| | Dermal | rat | >2,000 mg/Kg | >2,000/mg/kg |
| | LD₅₀ | | | |
| Irritation/ | Irritation to eye | rabbit | no | slightly irritating |
| corrosion | Irritation to skin | rabbit | no | moderately irritating |
| | Sensitization | guinea pig | no | no |
| Ecological | Fish | | >1,000 mg/L | >3.6 mg/L |
| information | LC₅₀ (96 h) | | | (Oncorhynchus |
| | | | | mykiss) |
| | | | | >8.9 mg/L (Lepomis |
| | | | | macrochirus) |
| | Aquatic plants | green algae | 12.0 mg/L (72 h) | >1 mg/L (96 h) |
| | EC₅₀ | | | |
| | Non-mammals | honey bee | 200 μg/bee | 1.87 μg/bee |
| | Residues on | Bean | 0.0160 | Not available |
| | treated | Bean field soil | 0.0034 | |
| | crop and soil | Rice leaf | 0.0952 | |
| | (μg/ml) | Rice field soil | 0.0003 | |
| | | Rice field | Undetectable | |
| | | water | | |
| | | Cucumber | Undetectable | |
| | | field soil | | |
| | | Hay | 0.1133 | |
| | | Husk | 0.1113 | |
| | | Rice grain | 0.0350 | |
| | | Wheat grain | 0.0002 | |

^{z}Data were obtained from ningnanmycin manufacturer, Deqiang Biological Co., LTD. Harbin, Helongjiang, China
^{y}Data were from Trinity 1.69SC fungicide Material Safety Data Sheet by BASF Corporation, Research Triangle Park, NC.

In an effort to search for an effective biocide for golf course disease management, ningnanmycin was selected due to its unique status and favorable toxicological profile. It was hypothesized that ningnanmycin may provide turfgrass managers with an additional strategy for management of chronic diseases like dollar spot and anthracnose. The study objectives were to: (1) evaluate the in vitro activity of ningnanmycin against S. homoeocarpa and C. cereale (causal agent of turf anthracnose); (2) compare ningnanmycin to a traditional synthetic fungicide for control of dollar spot and anthracnose on creeping bentgrass maintained under golf course putting green conditions; and (3) evaluate different application rates, intervals and alternations of ningnanmycin to determine its feasibility as part of an integrated management program.

### Material and Methods

In Vitro Sensitivity Assay.

Three isolates of S. homoeocarpa and two isolates of C. cereale were selected to evaluate ningnanmycin (Ningnanmycin 10WP, Deqiang Biological Co., LTD. Harbin, Helongjiang, China) in vitro activities using 5 three-fold dilutions from 0.81 to 0.01 μg a.i./ml. Triticonazole (technical grade, 93.3% active ingredient, BASF Corporation, Research Triangle Park, N.C.) was included in the assay as a standard for comparison. Based on preliminary experiments, five dilutions of triticonazole were used, ranging from 0.81 to 0.01 μg a.i/ml for isolates of S. homoeocarpa and from 6.25 to 0.01 μg a.i./ml for isolates of C. cereale. All isolates were prepared for long-term storage on pieces of dried filter paper maintained at −80° C. Filter paper sections containing each isolate were removed from −80° C. storage and placed on PDA amended with 0.05 μg/ml each of chloramphenicol, streptomycin, and tetracycline (PDA+++). After 3 days, mycelium-containing plugs (1×1 cm) were transferred to water agar for another 2 days. Then, water agar plugs (0.45 cm diameter) were cut from the periphery of the colony using a cork borer and placed on the center of Petri dishes containing non-amended PDA and PDA amended with the serial concentrations of each fungicide with three replicates per isolate. Radial growth was measured after three days (72 h) incubation at room temperature for isolates of S. homoeocarpa and seven days for isolates of C. cereale. Relative Growth (RG) was calculated by dividing colony diameter on amended PDA by that on the non-amended PDA. EC₅₀ values were then calculated using the method described by Secor et al. (Fungicide resistance assays for fungal plant pathogens. Methods Mol Biol. 835:385-392, 2012). The in vitro sensitivity assay repeated twice and EC₅₀ value of each isolates was determined as the mean of EC₅₀ values from two assays.

Field Efficacy Test:

Ninganmycin 10WP (ningnanmycin, Deqiang Biological Co., LTD.) was evaluated for control of dollar spot and anthracnose on creeping bentgrass maintained under golf course putting green conditions in 2010 and 2011. Trinity 1.69SC (triticonazole, BASF Corporation, Research Triangle Park, N.C.) was included in both years as the standard control. The trials were conducted at the Lake Wheeler Turfgrass Field Laboratory in Raleigh, N.C. Dollar spot evaluations were conducted on Penncross' creeping bentgrass, whereas ‘Dominant Plus’ creeping bentgrass was used for anthracnose evaluations. Mowing was performed five times weekly at a height of 3.5 mm during the spring and fall and between 3.9 and 4.2 mm during summer month with clippings collected. The site for testing for control of dollar spot was received 209 kg ha⁻¹ of nitrogen in 2010 and 281 kg ha⁻¹ in 2011. The site for testing control of anthracnose was received 225 kg ha⁻¹ of nitrogen in 2010 and 280 kg ha⁻¹ in 2011. Plots were 1 m×1.8 m and arranged in a randomized complete block with four replications. Treatments were applied with a CO₂-powered boom sprayer at 276 kPa using flat fan nozzles (TeeJet 9508E; R&D Sprayers, Opelousas, La.) calibrated to deliver H₂O at 81.5 ml m⁻². All treatments and application intervals are indicated in Tables 3-6. In 2010, the experimental area for evaluation of ningnanmycin for dollar spot control was inoculated using rye grain infested with S. homoeocarpa isolates RE-18G-4, RE-18G-35, and LWC-5 at least one week before fungicide application to encourage dollar spot development. In 2011, no artificial inocula for dollar spot development were applied due to unusually high disease pressure (more than 100 dollar spot infection centers per plot) at initiation of the trial. Dollar spot incidence was assessed weekly by counting the number of infection centers per plot. The experimental area for testing ningnanmycin activity on anthracnose was inoculated with spore suspension of C. cereale prepared from isolates ABR1 and ABR12 during the late June each year. Anthracnose severity was assessed by estimating the percent turf area exhibiting anthracnose symptoms. Turf quality was assessed visually by estimating the overall uniformity, density, and color within each plot before every fungicide application and during each disease severity rating. Turfgrass quality was quantified using a 1-to-9 scale (9=best, 5=minimally acceptable, and 1=bare ground). Data were analyzed separately for each year through analysis of variance and means separation by Waller-Duncan k-ratio t test (k=100) (ARM, Gylling Data Management, Inc., Brooking, S. Dak.).

### Results

In Vitro Sensitivity Assay.

No significant differences were detected between two in vitro assays, therefore data were combined for analysis. Compared to triticonazole, ningnanmycin showed stronger in vitro activity against S. homoeocarpa and C. cereale isolates. The mean EC₅₀ values of S. homoeocarpa and C. cereale were 0.01 and 0.30 μg/ml, respectively, for ningnanmycin compared to 0.05 and 0.98 μg/ml for triticonazole (Table 2).

TABLE 2
Ningnanmycin and triticonazole effective concentrations inhibit 50%
of growth (EC₅₀) of isolates of Sclerotinia homoeocarpa,
Colletotrichum cereale and Rhizoctonia solani

| | | EC₅₀ (μg/ml) | |
|---|---|---|---|
| Pathogen | Identification | ningnanmycin | triticonazole |
| S. homoeocarpa | 761SHME | 0.02 | 0.05 |
| | LWC 27 | 0.01 | 0.06 |
| | PST4 | 0.01 | 0.03 |
| C. cereale | ABR1 | 0.36 | 1.24 |
| | ABR12 | 0.24 | 0.72 |

Field Efficacy Test:

In 2010, dollar spot severity was moderate to high during the experimental period. All treatments provided significant control of dollar spot compared to the untreated, with the exception of ningnanmycin applied at 0.15 g/m² on a 14-day interval on 27 July (Table 3). The best control was obtained with ningnanmycin (0.30 g/m², 7-day interval), followed by ningnanmycin (0.15 g/m², 7-day interval) and Trinity (0.32 ml/m², 14-day interval).

TABLE 3
Evaluation of ningnanmycin for control of dollar spot in 2010.

| | Dollar spot incidence^{y} | | | | | | | | | | | |
|---|---|---|---|---|---|---|---|---|---|---|---|---|
| Treatment, application rate | Jul. 14, | | Jul. 21, | | Jul. 27, | | Aug. 3, | | Aug. 11, | | Aug. 17, | |
| (g or ml/ml) and interval^{z} | 2010 | | 2010 | | 2010 | | 2010 | | 2010 | | 2010 | |
| ningnanmycin, 0.15 g, 7 d | 2 | b^{x} | 0 | b | 1 | b | 0 | b | 0 | b | 0 | b |
| ningnanmycin 0.30 g, 7 d | 1 | b | 0 | b | 0 | b a | 0 | b | 0 | b | 0 | b |
| ningnanmycin, 0.15 g, 14 d | 4 | b | 18 | b | 3 | b | 37 | b | 23 | b | 16 | b |
| ningnanmycin, 0.30 g, 14 d | 3 | b | 8 | b | 0 | b | 14 | b | 9 | b | 3 | b |
| tritconazole, 0.32 ml, 14 d | 2 | b | 4 | b | 1 | b | 2 | b | 0 | b | 0 | b |
| Control | 35 | a | 62 | a | 14 | a | 92 | a | 100 | a | 48 | a |

^{z}Ningnanmycin and triticonazole were applied with formulated products, Ningnanmycin 10WP and Trinity 1.69SC, respectively. The application was initiated one-week prior to the first disease rating date and reapplied at intervals indicated.
^{y}Dollar spot incidence was recorded as the number of dollar spot infection centers per plot
^{x}Means followed by same letter do not significantly differ (P value = 0.5, Waller-Duncan K = 100)

Significant anthracnose activity was also observed in the experimental area during August. Ningnanmycin (0.30 g/m², 7-day interval) provided the highest level of anthracnose control, whereas Ningnanmycin 0.15 g/m² 7-day interval and Trinity 0.32 ml/m² 14-day interval provided a satisfactory level of control (Table 4). Ningmanmycin 0.15 g/m² 14-day interval and 0.30 g/m² 14-day interval provided the lowest suppression of anthracnose but still provided significant suppression compared to the untreated. Treatments that provided effective control of anthracnose exhibited the highest turf quality during August.

In 2011, dollar spot disease infestation was severe in the experimental area prior to the initiation of treatments. Ningnanmycin 0.30 g/m² 7-day interval and 0.45 g/m² 14-day interval significantly suppressed dollar spot infestation after the first application and continued to provide a level of dollar spot control similar to Trinity during the entire experimental period from 9 September till 26 October (Table 5). Ningnanmycin 0.15 g/m² 7-day interval and 0.30 g/m² 14-day interval, although providing significant disease suppression compared to the control from 9 September to 4 October, the levels of disease control were lower than Trinity. Starting 5 October, these two treatments were adjusted to higher rates of Ningnanmycin (0.45 g/m² on a 7-day interval and 0.60 g/m² on a 14-day interval, respectively). Dollar spot control was significantly improved on the corresponding plots in the following week. The treatment of 0.45 g/m² 7-day interval completely eliminated dollar spot from the testing plots after the second application. In the last three ratings from October 12 to October 26, all treatments including Ningnanmycin 7-day interval at 0.30 g/m² and 0.45 g/m², 14-day interval at 0.45 g/m² and 0.60 g/m², and Trinity 14-day interval at 0.32 ml/m² provided significantly improved turf quality compared to the control (Table 5).

In the 2011 anthracnose control experiment, Ningnanmycin (0.15 g/m², 7-day) continued to provide a similar level of control compared to Trinity for the second year (Table 6). The rotation between Ningnanmycin and Trinity provided superior anthracnose control compared to either material used alone. Treatments with Ningnanmycin applied at lower rates (0.08 g/m², 7-day) or longer application intervals (greater than 7 days) did not consistently provide satisfactory disease during the experiment period. Nevertheless, most of the treatments provided some improvement in visual turf quality.

### Discussion

Though some reports of disease-fighting activity of ningnanmycin in crops has been reported for ningnanmycin, it had never been tested on any turf disease. Turf anthracnose has been an emerging disease in the last 20 to 30 years mainly due to increasingly harsh management regimes designed to enhance playability for golfers. Factors such as minimal nitrogen fertilization, decreased cutting heights, variability in fungicide efficacy, and the increased usage of plant growth regulating chemicals have all been implicated in the enhancement of stresses and maladies of creeping bentgrass (Dernoeden, P. H. 2000. Stresses and maladies of creeping bentgrass. Pages 44-48 in: Creeping Bentgrass Management: Summer Stresses, Weeds and Selected Maladies. Ann Arbor Press, Chelsea, Mich.). Typically there is no such harsh management in crop plants, and there are no diseases in crops caused by Sclerotinia homoeocarpa or Collectotrichum cereale. On the other hand, S. homoeocarpa infects all grasses grown for turf.

Ningnanmycin was evaluated for its activity against dollar spot and anthracnose on creeping bentgrass maintained under golf course putting green conditions in 2010 and 2011. The results of the field experiments demonstrate that ningnanmycin has activity against dollar spot and anthracnose, two of the most important turfgrass diseases, and can provide similar levels of control compared to traditional fungicides. In addition, no plant growth regulator effects were observed in plots treated with ningnanmycin, which is a common problem with DMI fungicides (Burden et al. 1987. Effects of sterol biosynthesis inhibiting fungicides and plant-growth regulators on the sterol composition of barley plants. Pestic Biochem Phys 27:289-300; Vyas, S. C. 1988. NONTARGET EFFECTS OF AGRICULTURAL FUNGICIDES (Boca Raton, Fla.)). Ningnanmycin-treated plots exhibited improved turfgrass quality as compared to triticonazole and untreated plots in several ratings in both 2010 and 2011. This could be due to certain nutrients such as amino acids, vitamins and minerals produced during the fermentation process, which were utilized by treated plants as foliar fertilizer. The benefit of ningnanmycin on improving plant growth and quality has been also reported in several crops (Hu et al. 1997. A new agricultural antibiotic-ningnanmycin. China Patent: ZL 93104287.9; Hu et al. 1998. Studies on appliation of ningnanmycin to mosaic diseases of tobacco. Chin. J. Appl. Environ. Biol. 4:390-395; Zhao. 2000. Evaluation of ningnanmycin for control of powdery mildew on peas. Pesticide 39:41).

Additionally, ningnanmycin demonstrated in vitro activity against Ophiosphaerella herpotricha (spring dead spot), Magnaporthe poae (summer patch) and M. griesea (turf gray leaf pot) in a preliminary experiment (Ma, unpublished data), which work suggested to us the potential of ningnamycin for use in turfgrass disease management.

Besides its disease control efficacy, environment and product safety, ningnanmycin has several advantages over conventional chemical pesticides from sustainability and economic standpoints. Firstly, it can be produced from renewable agricultural products such as soybean husks through fermentation (Hu et al. 1997. A new agricultural antibiotic-ningnanmycin. China Patent: ZL 93104287.9). Secondly, it can be produced using existing fermentation equipment and facilities, whereas in the case of chemical pesticides, a new set of production plant and waste disposal facilities is often required for each pesticide in order to meet increasingly strict environmental and public safety standards (Yamaguchi, I. 1998. Natural product-derived fungicides as exemplified by the antibiotics. Pages 57-85 in: FUNGICIDAL ACTIVITY: CHEMICAL AND BIOLOGICAL APPROACHES TO PLANT PROTECTION (D. H. Huston and J. Miyamoto, eds. John Wiley & Sons Ltd.)). Lastly, the fermentation broth requires minimal processing before producing final products. The ningnanmycin fermentation broth was simply filtered, condensed, and completed with the addition of 0.1% sodium benzoate for preservation (Hu et al. 1997. A new agricultural antibiotic-ningnanmycin. China Patent: ZL 93104287.9).

Despite the above merits, there are limiting factors as well. One disadvantage is the difficulty in extraction and purification of ningnanmycin from fermentation broth. To obtain technical grade ningnanmycin, the fermentation broth is often processed through iron exchange resin, macroporous weak cationic exchange resin and neutral aluminum oxide column chromatograph and finally purified with high performance liquid chromatograph (HPLC) (Hu et al. 1997. A new agricultural antibiotic-ningnanmycin. China Patent: ZL 93104287.9). This adds difficulties in product quality control that are often required for domestic and international trade. However, the greatest challenge for ningnamycin use in U.S. agriculture might be the concern of antibiotic resistance risk to human medicine. This is because ningnamycin is also generated through fermentation of Streptomyces species, similar to that of streptomycin and oxytetracycline, two of the most commonly used agricultural antibiotics. In reality, however, various products were generated through fermentation of Streptomyces spp. Examples of such products used in U.S. agriculture include the avermectin insecticides and the polyoxin biochemical fungicides (Yamaguchi, I. 1998. Natural product-derived fungicides as exemplified by the antibiotics. Pages 57-85 in: FUNGICIDAL ACTIVITY: CHEMICAL AND BIOLOGICAL APPROACHES TO PLANT PROTECTION (D. H. Huston and J. Miyamoto, eds. John Wiley & Sons Ltd.)). Avermectins, produced through fermentation of S. avermitilis, control insects through binding of gamma-aminobutyric acid (GABA) in nerve endings, which leads to paralysis of the neuromuscular systems in insects. Whereas in mammals, GABA receptors are primarily in the brain and avermectins do not readily cross the blood brain barrier at therapeutic doses (Bloomquist. 1993. Toxicology, Mode of Action and Target Site-Mediated Resistance to Insecticides Acting on Chloride Channels. Comparative Biochemistry and Physiology C-Toxicology & Pharmacology 106:301-314). In the example of polyoxins, it selectively inhibits the synthesis of fungal cell-wall chitin, which does not exist in mammalian cells (Yamaguchi, I. 1998. Natural product-derived fungicides as exemplified by the antibiotics. Pages 57-85 in: FUNGICIDAL ACTIVITY: CHEMICAL AND BIOLOGICAL APPROACHES TO PLANT PROTECTION (D. H. Huston and J. Miyamoto, eds. John Wiley & Sons Ltd.)).

In addition, ningnanmycin does not appear to have antibacterial activity based on a preliminary study that found ningnanmycin at 100 ug/ml did not show any in vitro activity on Xanthomonas pruni, X. translucent, Pantoea ananatis or Acidovorax aveane (Ritchie and Ma, unpublished data).

Although ningnanymycin has been reported as having activity against Xanthomonas oryzae infecting rice (bacterial blight of rice) and Pythium aphanidermatum infecting soybean in China (soybean root rot) (Hu et al., 1997. A new agricultural antibiotic-ningnanmycin. Chinese Patent ZL 93104287.9; Liu et al., 2005. Bioassay of matrine.ningnanmycin 6.5% ZF on Pythium aphanidermatum. Pesticide Science and Administration. 26: 16-19), we have not been able to detect any activity against strains of X. translucent and P. aphanidermatum infecting turfgrass at a concentration of ningnanmycin at 100 ppm ad. This indicates that pathogens from the same genera or species but infecting different hosts may have a different fungicide sensitivity profile.

Although ningnanmycin showed in vitro activity on Rhizoctonia solani (AG2-2IIIB) causing brown patch on creeping bentgrass, it showed little to no efficacy against the disease in a preliminary field experiment. In addition, ningnanmycin had no in vitro activity on Pythium aphanidermaturm.

Evaluations of ningnanmycin against other turfgrass pathogens are performed in a similar manner to determine its spectrum of activity. Included is testing for spring dead spot, summer patch, and gray leaf spot, on which ningnanmycin has been identified to have in vitro activity.

TABLE 5
Evaluation of ningnanmycin for control of dollar spot in and impact on turf quality in 2011

| | Dollar spot incidence^{y} | | | | | | | | | | | | | |
|---|---|---|---|---|---|---|---|---|---|---|---|---|---|---|
| Treatment, application rate | Sep. 9, | | Sep. 16, | | Sep. 26, | | Oct. 4, | | Oct. 12, | | Oct. 18, | | Oct. 26, | |
| and interval^{z} | 2011 | | 2011 | | 2011 | | 2011 | | 2011 | | 2011 | | 2011 | |
| ningnanmycin, 015 g, 7 d | 42 | ab^{x} | 60 | b | 30 | bc | 27 | b | — | | — | | — | |
| ningnanmycin, 0.45 g, 7 d | —^{w} | | — | | — | | — | | 5 | bc | 0 | c | 0 | c |
| ningnanmycin, 0.30 g, 14 d | 31 | bc | 20 | bc | 57 | b | 30 | b | — | | — | | — | |
| ningnanmycin, 0.60 g, 14 d | — | | — | | — | | — | | 5 | b | 6 | b | 7 | b |
| ningnanmycin, 0.30 g, 7 d | 11 | cd | 6 | cd | 5 | d | 2 | c | 1 | c | 1 | c | 0 | c |
| ningnanmycin, 0.45 g, 14 d | 5 | d | 3 | d | 14 | cd | 5 | c | 2 | bc | 1 | c | 1 | c |
| triticonazole, 0.32 ml, 14 d | 3 | d | 16 | c | 6 | d | 5 | c | 2 | bc | 2 | bc | 2 | bc |
| Control | 112 | a | 222 | a | 294 | a | 243 | a | 174 | a | 388 | a | 462 | a |

| | Turf quality^{v} | | |
|---|---|---|---|
| Treatment, application rate | Oct. 12, | Oct. 18, | Oct. 26, |
| and interval | 2011 | 2011 | 2011 |
| ningnanmycin, 015 g, 7 d | — | — | — |
| ningnanmycin, 0.45 g, 7 d | 6.4 b | 7.9 a | 7.6 a |
| ningnanmycin, 0.30 g, 14 d | — | — | — |
| ningnanmycin, 0.60 g, 14 d | 6.6 ab | 7.4 a | 7.1 a |
| ningnanmycin, 0.30 g, 7 d | 7.1 a | 7.9 a | 7.6 a |
| ningnanmycin, 0.45 g, 14 d | 7.1 a | 7.9 a | 7.6 a |
| triticonazole, 0.32 ml, 14 d | 6.5 ab | 7.4 a | 7.1 a |
| Control | 3.9 c | 3.3 b | 2.3 b |

^{z}Ningnanmycin and triticonazole were applied with formulated products, Ningnanmycin 10WP and Trinity 1.69SC, respectively. The application was initiated one-week prior to the first disease rating date and reapplied at intervals indicated.
^{y}Dollar spot incidence was recorded as the number of dollar spot infection centers per plot.
^{x}Means followed by same letter do not significantly differ (P value = 0.5, Waller-Duncan K = 100).
^{w}“—” no disease rating available due to no corresponding treatment was applied
^{v}Turfgrass quality was quantified using a 1-to-9 scale (9 = best, 5 = minimally acceptable, and 1 = bare ground).

TABLE 6
Evaluation of ningnanmycin for control of anthracnose
and impact on turfgrass quality in 2011

| | Anthracnose severity (%)^{y} | | | | | | | | Turf quality^{w} | | | |
|---|---|---|---|---|---|---|---|---|---|---|---|---|
| Treatment, application rate | Jul. 25, | | Aug. 1, | | Aug. 8, | | Aug. 15, | | Aug. 8, | | Aug. 15, | |
| and interval^{z} | 2011 | | 2011 | | 2011 | | 2011 | | 2010 | | 2010 | |
| ningnanmycin, 0.08 g, 7 d | 20 | ab^{x} | 16 | bc | 4 | cd | 15 | ab | 5 | bc | 4 | cd |
| ningnanmycin, 0.15 g, 7 d | 17 | b | 9 | bc | 3 | cd | 9 | b | 5 | b | 5 | a |
| ningnanmycin, 0.15 g, 10 d | 21 | ab | 18 | bc | 8 | b | 17 | ab | 5 | cd | 4 | abc |
| ningnanmycin, 0.30 g, 10 d | 16 | b | 20 | b | 3 | cd | 15 | ab | 5 | b | 4 | bcd |
| ningnanmycin, 0.30 g, 14 d | 20 | ab | 14 | bc | 6 | bc | 13 | ab | 4 | de | 4 | abc |
| triticonazole, 0.32 ml, 14 d | 16 | b | 17 | bc | 3 | cd | 12 | b | 5 | bc | 5 | ab |
| triticonazole, 0.32 ml alternate | | | | | | | | | | | | |
| ningnanmycin, 0.15 g, 14 d | 12 | b | 11 | bc | 1 | d | 7 | b | 5 | a | 5 | ab |
| triticonazole, 0.32 ml alternate | | | | | | | | | | | | |
| ningnanmycin, 0.30 g, 14 d | 15 | b | 7 | c | 3 | cd | 9 | b | 5 | ab | 4 | abc |
| Control | 35 | a | 44 | a | 14 | a | 28 | a | 4 | e | 3 | d |

^{z}Ningnanmycin and triticonazole were applied with formulated products, Ningnanmycin 10WP and Trinity 1.69SC, respectively. The application was initiated one-week prior to the first disease rating date and reapplied at intervals indicated.
^{y}Anthracnose severity was assessed by estimating the percent turf area exhibiting anthracnose symptoms.
^{x}Means followed by same letter do not significantly differ (P value = 0.5, Waller-Duncan K = 100).
^{w}Turfgrass quality was quantified using a 1-to-9 scale (9 = best, 5 = minimally acceptable, and 1 = bare ground).

The foregoing is illustrative of the present invention, and is not to be construed as limiting thereof. The invention is defined by the following claims, with equivalents of the claims to be included therein.

That which is claimed is:

1. A method of controlling a fungal disease in a turfgrass or plant part thereof, comprising applying a composition comprising ningnanmycin to said turfgrass or plant part thereof in an amount effective to control said fungal disease.

2. The method of claim 1, wherein said turfgrass is selected from the group consisting of: bahiagrass, bentgrass such as creeping bentgrass and colonial bentgrass, bermudagrass, hybrid bermudagrass, bluegrass such as annual bluegrass, Kentucky bluegrass or rough bluegrass, buffalograss, carpetgrass, centipedegrass, fescue such as fine fescue or tall fescue, ryegrass such as annual ryegrass or perennial ryegrass, kikuyugrass, orchardgrass, quackgrass, seashore paspalum, St. Augustinegrass, and zoysiagrass.

3. The method of claim 1, wherein said turfgrass is selected from the group consisting of: creeping bentgrass, perennial ryegrass, annual bluegrass, Kentucky bluegrass, hybrid bermudagrass and zoysiagrass.

4. The method of claim 1, wherein said fungal disease is selected from the group consisting of: Ascochyta Leaf Blight, Brown Stripe, Cephalosporium Stripe, Cercospora Leaf Spot, Cladosporium Eyespot, Copper Spot (Zonate Leaf Spot), Dollar Spot, Gray Leaf Spot, Leaf Blotch (Scald), Leaf Smut, Leptoshaerulina Leaf Blight, Mastigosporium Leaf Spot, Phyllosticta Leaf Blight, Physoderma Leaf Spot, Physoderma Leaf Streak, Pink Patch Leaf Bight, Cream Leaf Bight, Powdery Mildew, Pseudoseptoria Leaf Spot, Red Thread, Rust, Septoria Leaf Spot, Stagnospora Leaf Spot, Snow Mold, Coprinus Snow Mold, Microdochium Patch, Snow Scald, Typhula Blight, Spermospora Leaf Spot, Tar Sport, Yellow Tuft (Downy Mildew), Anthracnose, Bipolaris Disease, Exseohilum Disease, Curvularia Disease, Drechslera Disease, Marielliottia Disease, Fusarium Disease, Nigrospora Blight, Pythium Disease, Rhizoctonia Disease, Seedling Disease, Southern Blight, Dead Spot, Necrotic Ring Spot, Root Decline of Warm-Season Turfgrasses, Spring Dead Spot, Summer Patch and Take-all Patch.

5. The method of claim 1, wherein said fungal disease is caused by a species from the genus selected from the group consisting of: Sclerotinia, Colletotrichum, Ophiosphaerella, and Magnaporthe.

6. The method of claim 1, wherein said fungal disease is dollar spot caused by Sclerotinia homoeocarpa.

7. The method of claim 1, wherein said fungal disease is anthracnose caused by Colletotrichum cereale.

8. The method of claim 1, wherein said applying is carried out at a rate of from 5 grams to 500 kilograms of said composition per hectare.

9. The method of claim 1, wherein said applying is carried out at a rate of from 100 grams to 1,000 grams of said composition per hectare.

10. The method of claim 1, wherein said applying is carried out at a rate of from 0.10 to 1.0 g/m² of ningnanmycin.

11. The method of claim 1, wherein said applying is carried out at a rate of from 0.15 to 0.5 g/m² of ningnanmycin.

12. The method of claim 1, wherein said applying is carried out at an interval of every 5, 7, 10, 14, or 21 days.

13. A method of controlling a fungal disease in a turfgrass or plant part thereof, comprising:
applying a composition comprising ningnanmycin; and
concurrently applying a composition comprising another fungicide,
to said turfgrass or plant part thereof in an amount effective to control said fungal disease.

14. The method of claim 13, wherein said fungicide is a benzimidazole, a dicarboximide, or a demethylation inhibitor fungicide (DMI).

15. The method of claim 13, wherein said fungicide is selected from the group consisting of: chloronitriles (e.g., chlorothalonil), phenylpyrrole (e.g., fludioxonil), and phosphonates (e.g., fosetyl-A1, phosphite (salts of phosphorous acid)).

16. The method of claim 13, wherein said fungicide is a contact, translaminar or systemic fungicide.

17. The method of claim 13, wherein said turfgrass is selected from the group consisting of: bahiagrass, bentgrass such as creeping bentgrass, bermudagrass, bluegrass such as Kentucky bluegrass or rough bluegrass, buffalograss, carpetgrass, centipedegrass, fescue such as fine fescue or tall fescue, ryegrass such as annual ryegrass or perennial ryegrass, St. Augustinegrass, and zoysiagrass.

18. The method of claim 13, wherein said turfgrass is selected from the group consisting of: bentgrass, hybrid bermudagrass and zoysiagrass.

19. The method of claim 13, wherein said fungal disease is dollar spot caused by Sclerotinia homoeocarpa.

20. The method of claim 13, wherein said fungal disease is anthracnose caused by Colletotrichum cereale.

21. The method of claim 13, wherein said composition comprising ningnanmycin and said composition comprising another fungicide are applied sequentially.

22. The method of claim 13, wherein said composition comprising ningnanmycin and said composition comprising another fungicide are applied simultaneously.

23. The method of claim 13, wherein said applying is carried out at a rate of from 0.10 to 1.0 g/m² of ningnanmycin.

24. The method of claim 13, wherein said applying is carried out at a rate of from 0.15 to 0.5 g/m² of ningnanmycin.

25. The method of claim 13, wherein said applying is carried out sequentially at an interval of every 5, 7, 10, 14, or 21 days.

26. A composition comprising ningnanmycin and an aqueous carrier, wherein said ningnanmycin is provided at a concentration of from 0.001 to 20 micrograms per milliliter.

27. The composition of claim 26, wherein said ningnanmycin is provided at a concentration of from 0.01 to 2 micrograms per milliliter.

28. The composition of claim 26, wherein said composition further comprises another fungicide.

29. The composition of claim 28, wherein said fungicide is a benzimidazole, a dicarboximide, or a demethylation inhibitor fungicide (DMI).

30. The composition of claim 28, wherein said fungicide is selected from the group consisting of: chloronitriles (e.g., chlorothalonil), phenylpyrrole (e.g., fludioxonil), and phosphonates (e.g., fosetyl-A1, phosphite (salts of phosphorous acid)).

31. The composition of claim 28, wherein said fungicide is a contact, translaminar or systemic fungicide.
